(19) United States
(12) Patent Application Publication
(10) Pub. No.: US 2026/0220578 A1
(43) Pub. Date: Jul. 30, 2026

(54) SYSTEMS AND METHODS FOR SCENARIO GENERATION AND ANALYSIS

(71) Applicant: Wells Fargo Bank, N.A., San Francisco, CA (US)

(72) Inventors: Govinda Rajulu Nelluri, Hyderabad (IN); Rameshchandra Bhaskar Ketharaju, Hyderabad (IN); Ramya Balasubramanian, Secunderabad (IN)

(21) Appl. No.: 19/039,343

(22) Filed: Jan. 28, 2025

(51) Int. Cl. G06Q 10/0635; G06Q 40/06

(52) U.S. Cl. CPC G06Q 10/0635; G06Q 40/06

(57) ABSTRACT

Systems and methods are disclosed herein for scenario generation and analysis. An example method includes receiving and event and determining a subject matter context to the event. The example method also includes modifying the event based on the subject matter context to prepare a contexed event and generating a prompt based on the contexed event. The example method also includes selecting an agent model based and determining whether the subject matter context relates to a treasury and an associated persona. The example method also includes identifying a historical contexed event from an event corpus that includes pairs of contexed events and descriptions of impacts to a related subject-matter context, and generating a predictive treasury scenario based on the historical contexed event, the treasury, the persona, and the contexed event. The example method also includes generating a risk assessment of the possible response and a response to the contexed event.

### BACKGROUND

Advances in generative artificial intelligence (GAI) have enabled the generation of images, text, and other media. GAI has been integrated into many industries, improving productivity and innovation. Treasury management focuses on optimizing liquidity, ensuring cash flow, and managing the risks thereof.

### BRIEF SUMMARY

Treasurers typically rely on manual analysis for scenario testing in cash reserve management, which may be time-consuming, resource-intensive, and prone to error. Treasurers are faced with the challenge of evaluating the impact of various scenarios on cash positions.

While treasurers typically rely on difficult manual analysis for scenario testing, they are met by additional challenges including the increasing complexity of financial markets, a difficulty in processing the large volume of financial data, and a demand for increasingly quick and accurate decisions. Treasurers require innovative tools that can provide actionable insights to identify risks and opportunities in their cash positions.

At the same time, generative artificial intelligence (GAI) technology has advanced rapidly, creating opportunities to innovate in applying this tool to different problems. GAI and, more broadly, artificial intelligence (AI), have the capacity to quickly and accurately synthesize large, complex datasets and provide useful outputs such as decisions, classifications, and/or generated data. The present disclosure recognizes and points out advantages over existing treasury management practices that are gained by leveraging GAI in several related areas. For example, GAI may capture complex patterns and relationships in data to advance financial analysis and forecasting. GAI may also provide customer support and personalized financial advice in the context of conversational finance. Further, GAI may support document analysis by extracting information from financial documents.

Accordingly, the present disclosure sets forth systems, methods, and apparatuses that generate scenarios using GAI for treasury management. A GAI model may ingest a variety of data inputs, including market data, customer data, macroeconomic data, government policies, industry-specific data, employment data, and the like. The GAI model may act on particular triggers to generate scenarios, including user defined triggers, real-time market triggers, event-based triggers, scheduled triggers, and historical data analysis triggers.

The GAI scenario generation system may generate various scenarios for testing in the context of treasury management. For example, an interest rate increase scenario may be generated that provides projections of cash position impact, risk identification, and actionable insights and recommendations. In particular, the interest rate increase scenario may determine the cash position impact to be increased borrowing costs, reduced investment returns, and impact on debt servicing. The scenario may also highlight risk areas in which cash flow may be negatively impacted. Actionable insights may include alternative investment options, interest rate hedging strategies, optimizing debt structuring or refinancing, and exploring interest rate swap agreements.

Another example scenario may be a market disruption event. The cash position impact of such a scenario may include changes in asset valuations and liquidity challenges. The scenario may highlight areas in which cash flow can be negatively impacted, and provide recommendations to adjust and/or diversify investment portfolios, develop risk management strategies, get updates from markets and trends, reallocate assets, explore new investments, or the like.

Another example scenario may be a regulatory change. The cash position impact of such a scenario may include changes in cash flows, tax obligations, and compliance costs. The scenario may highlight areas in which a cash position may be negatively impacted due to non-compliance or unexpected cost increases and provide recommendations to engage with legal or tax advisors to explore tax incentives and/or optimize tax planning strategies, proactively monitor and address compliance requirements, and streamline the compliance process.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for generating and analyzing scenarios for treasury management, in accordance with some example embodiments described herein.

FIG. 2 illustrates a schematic block diagram of example circuitry embodying a treasury management system that may perform various operations in accordance with some example embodiments described herein.

FIG. 3A illustrates another view of an example system for generating and analyzing scenarios for treasury management, in accordance with some example embodiments described herein.

FIG. 3B illustrates another view of an example system for generating and analyzing scenarios for treasury management, in accordance with some example embodiments described herein.

FIG. 3C illustrates another view of an example system for generating and analyzing scenarios for treasury management, in accordance with some example embodiments described herein.

FIG. 3D illustrates another view of an example system for generating and analyzing scenarios for treasury management, in accordance with some example embodiments described herein.

FIG. 4 illustrates an example flowchart for generating scenarios for treasury management, in accordance with some example embodiments described herein.

FIG. 5A illustrates an example flowchart for receiving information from distributed ledgers for generating events, in accordance with some example embodiments described herein.

FIG. 5B illustrates an example flowchart for receiving events by a customer prompt, in accordance with some example embodiments described herein.

FIG. 5C illustrates an example flowchart for receiving events based on treasury transactions, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

The term “block” may refer to a data structure associated with a blockchain, a type of distributed ledger. For example, a block may comprise a model definition data structure, a block header data structure, a technical data structure, a business data structure, an operational data structure, a next block information data structure, any other suitable electronic information or data structure associated therewith (including, but not limited to, links or pointers), or any combination thereof. A block header data structure may comprise a current block hash value data structure, a previous block hash value data structure, a next block hash value data structure, a Merkle root hash value data structure, a nonce value data structure, any other suitable electronic information or data structure associated therewith (including, but not limited to, links or pointers), or any combination thereof.

The term “blockchain” may refer to a digital ledger comprising a growing list of blocks. For example, a blockchain may comprise a plurality of blocks, any other suitable electronic information or data structure associated therewith (including, but not limited to, links or pointers), or any combination thereof.

The term “node device” or “node” may refer generally to a computing device, such as a server device, client device, a database server device, a data storage device, or a blockchain data storage device that stores one or more portions of a blockchain or other distributed ledger. For example, a node device may comprise a server device, a client device, a database, a database server device, any other suitable device or data structure associated therewith (including, but not limited to, links or pointers), or any combination thereof.

The term “sidechain” refers to a secondary blockchain that operates in parallel to a primary blockchain. The sidechain may set different standards for consensus, record-keeping, or other properties of the sidechain that are distinct from those of the primary blockchain. For example, a sidechain may have a lower transaction cost and faster transaction times due to a less difficult consensus requirement, or faster block times, trading off faster transactions for reduced security. Sidechains may also be permissioned, allowing an entity or consortium to manage a sidechain while still maintaining a connection to the primary blockchain. Sidechains also permit assets on the sidechain to move to and from the main chain when needed, typically by means of a two-way bridge between the two blockchains, where predetermined rules for exchange between the two blockchains are established.

### System Architecture

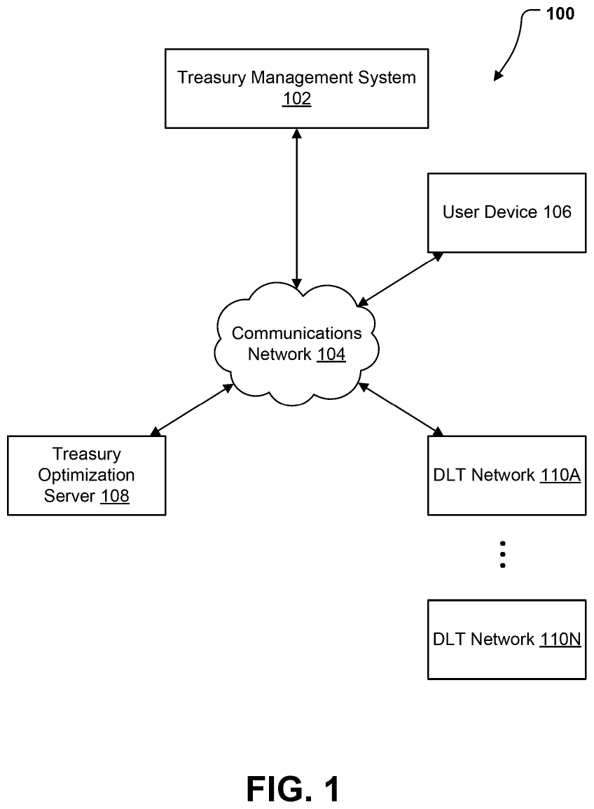

Example embodiments described herein may be implemented using any of a variety of computing devices or servers. To this end, FIG. 1 illustrates an example environment within which various embodiments may operate. As illustrated, a treasury management system 102 may receive and/or transmit information via communications network 104 (e.g., the Internet) with any number of other devices, such as user device 106, treasury optimization server 108, or DLT network 110A (distributed ledger) through DLT network 110N.

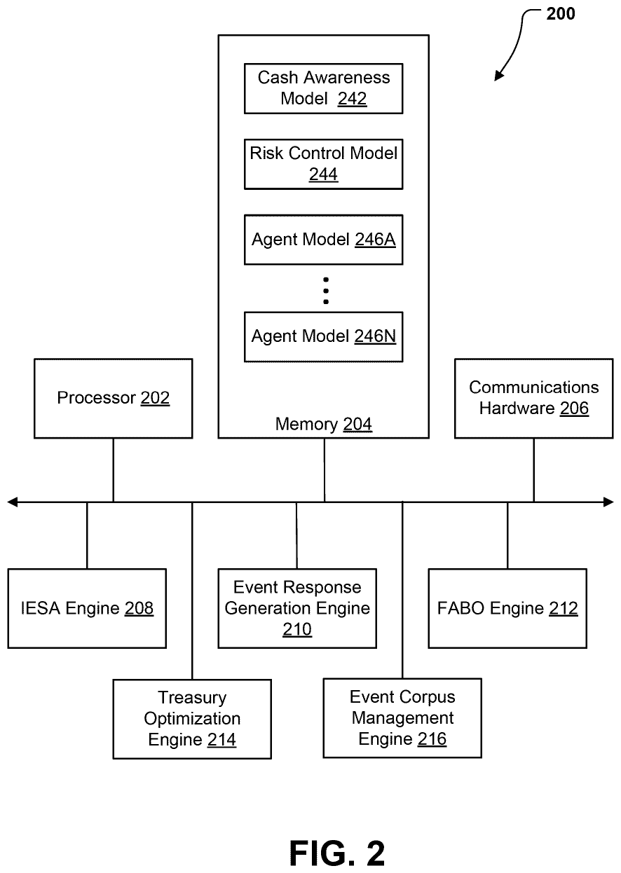

The treasury management system 102 may be implemented as one or more computing devices or servers, which may be composed of a series of components. Particular components of the treasury management system 102 are described in greater detail below with reference to apparatus 200 in connection with FIG. 2.

The user device 106 may be embodied by any computing devices known in the art. The user device 106 need not be an independent device but may be embodied as one or more peripheral devices communicatively coupled to other computing devices.

Treasury optimization server 108 may be a dedicated hardware server, a cloud service provided by a collection of servers, a virtual service, and/or the like. The treasury optimization server 108 may interface to treasury functionality within an organization, for example, providing the ability to query and perform transactions or other operations regarding cash balances. In some examples, the treasury optimization server 108 may be configured to receive a request to transfer balances or perform other transactions from the treasury management system 102 and act in real time. In other examples the treasury optimization server 108 may be configured to provide informational updates regarding balances, rates, and other data related to treasury management, including accounts related to a particular customer or group.

The series of DLT network 110A through DLT network 110N may be any distributed ledger systems known in the art, such as blockchain networks. The DLT network 110A-110N may be collections of networked node devices of a blockchain, which may be permissionless (public), or permissioned (private). The DLT network 110A-110N may use any distributed ledger or blockchain technology that is capable of creating and exchanging blockchain tokens or NFTs. In some embodiments, the DLT network 110A-110N may allow for Turing-complete scripting of contracts, known also as smart contracts, to be executed on the blockchain. The DLT network 110A-110N may be related to other distributed ledgers and/or blockchain networks not pictured here. For example, one or more of the DLT network 110A-110N may be a sidechain of another distributed ledger or blockchain network, or another network (not shown) may form a sidechain of one or more of the DLT network 110A-110N. The nodes may be embodied by servers or other networked computing devices, which may be specialized node devices, or may be embodied by any computing devices or server devices known in the art. In some embodiments the treasury management system 102 itself may be a node of one or more of the DLT network 110A-110N, or the treasury management system 102 may be external to the distributed ledgers.

### Example Implementing Apparatuses

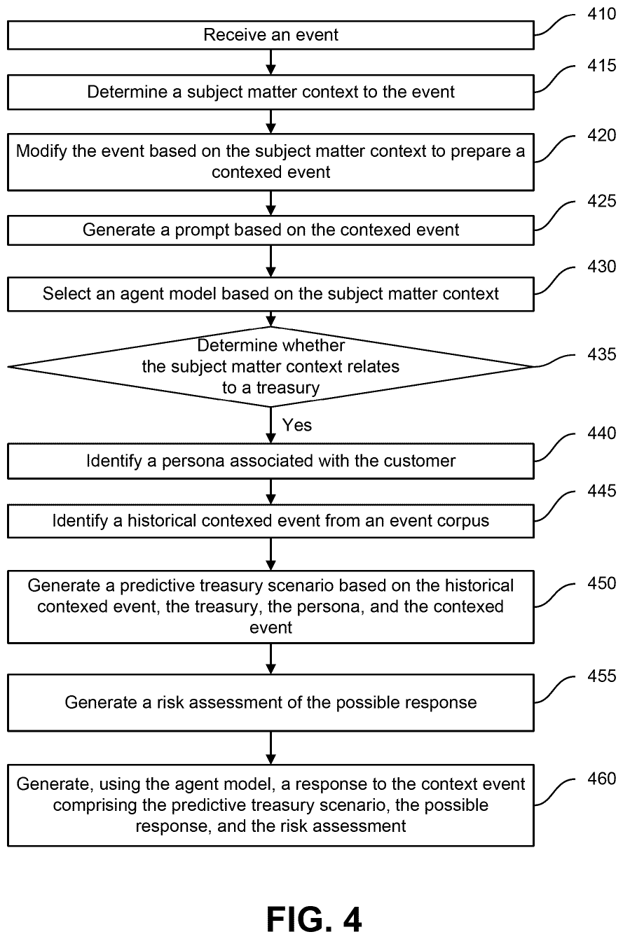

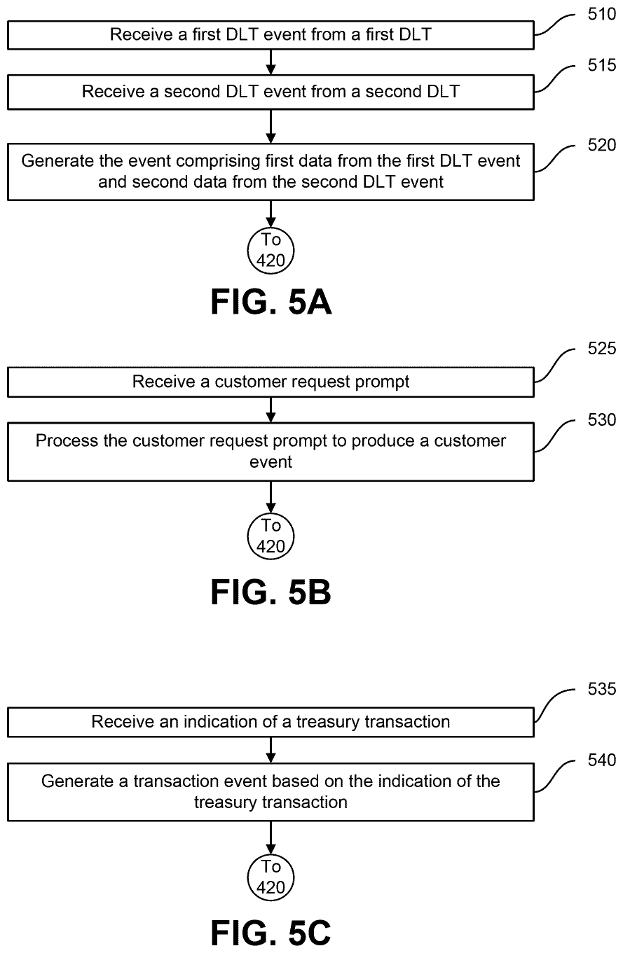

The treasury management system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 4-5C. As illustrated in FIG. 2, the apparatus 200 may include processor 202, memory 204, communications hardware 206, intelligent event standards accumulator engine (IESA engine 208), event response generation engine 210, financial AI bureau orchestrator engine (FABO engine 212), treasury optimization engine 214, and event corpus management engine 216, each of which will be described in greater detail below. Additionally, memory 204 may store various models and algorithms which may be executed by processor 202, other circuitry and/or other engines, including cash awareness model 242, risk control model 244, and agent model 246A through agent model 246N.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

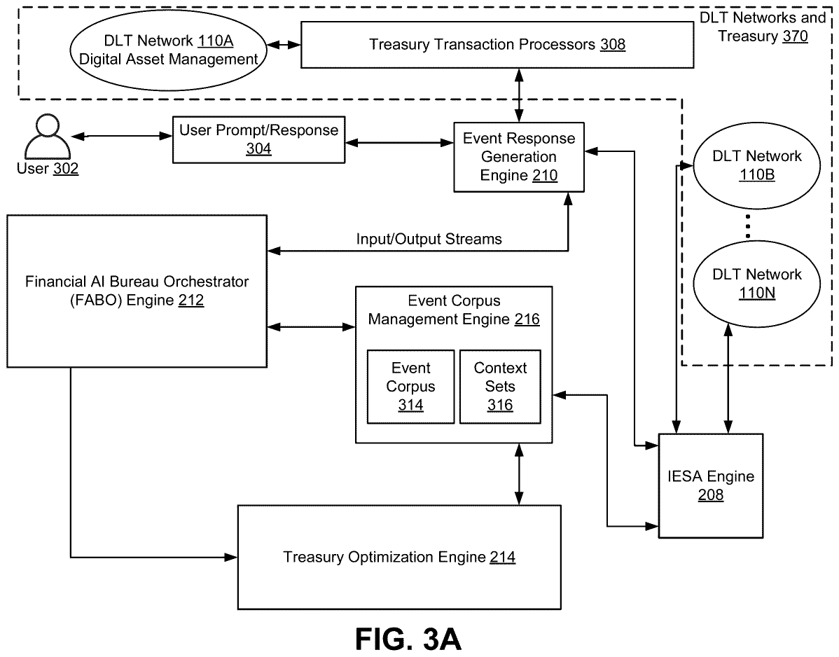

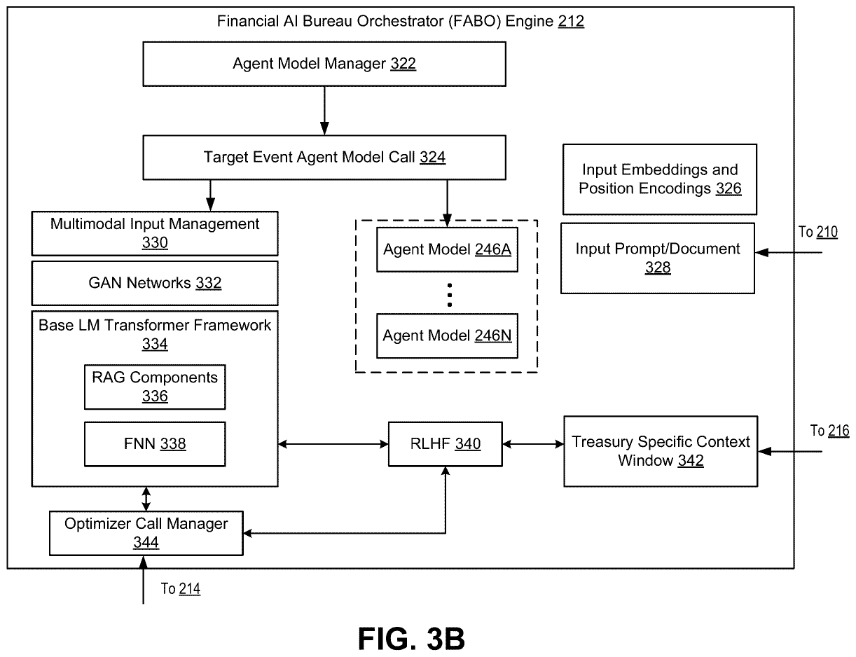

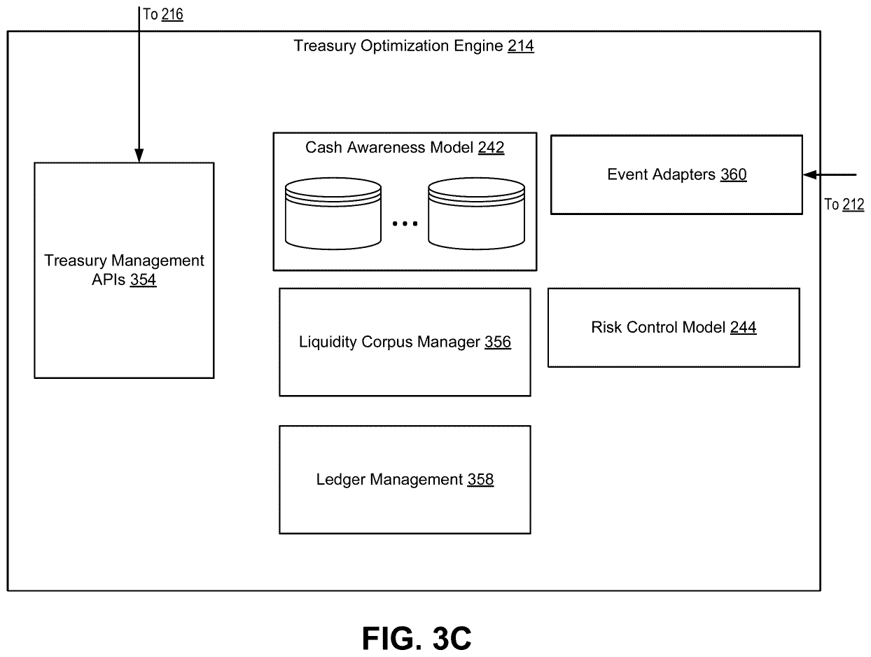

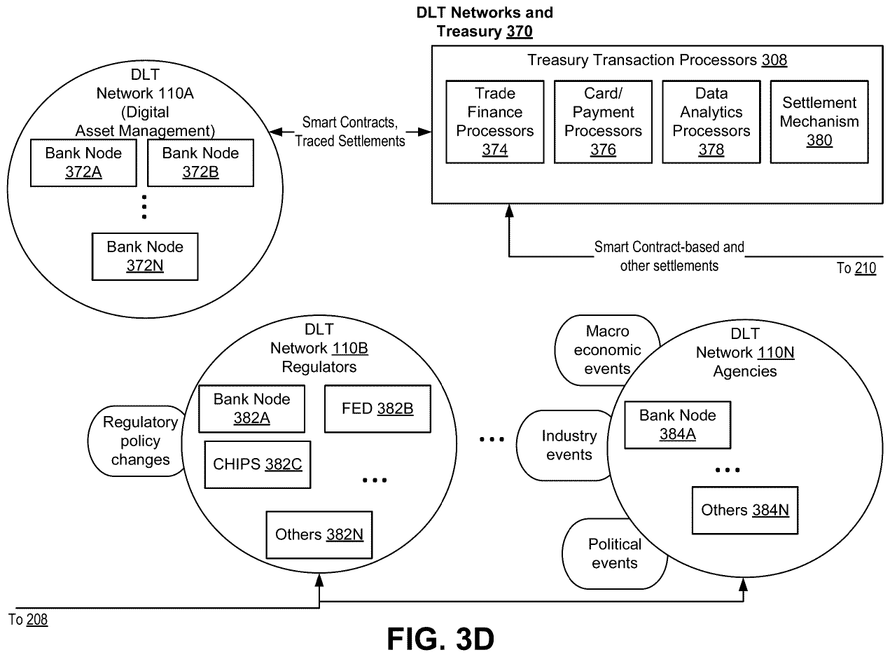

In addition, the apparatus 200 further comprises an (intelligent event standards accumulator (IESA engine 208) that collects events from input sources, including DLT networks, applies context to events, and provides contexed events to components of the apparatus 200. The IESA engine 208 may utilize processor 202, memory 204, or any other hardware component included in the apparatus 200 to perform these operations, as described in connection with FIGS. 3A-5C below. The IESA engine 208 may further utilize communications hardware 206 to gather data from a variety of sources (e.g., DLT network 110A through DLT network 110N), and/or exchange data with a user, and in some embodiments may utilize processor 202 and/or memory 204 to process and receive events and contexed events. In some embodiments, a contexed event may include a base event data object, which may be, for example, a structured text file with entries corresponding to text descriptions of the event, qualitative data (e.g., the data and time, systems directly related to the event) and/or other metadata. In some examples, the base event data object may be linked to other data, including other event data objects, via metadata of the event. In some embodiments, the event metadata may include descriptions of the nature of the connection to the other events and/or other data, which may form the context of the event. Accordingly, the base event data object together with linked event data and other linked data with descriptions of the nature of the linkages may be considered the contexed event. In some embodiments, the IESA engine 208 may be a DLT plugin that attaches to a node of heterogenous DLT network (e.g., DLT network 110A through DLT network 110N) and receives actionable events from the network. Upon receiving the actionable event, the IESA engine may push the event to event corpus management engine 216. In some embodiments, the IESA engine 208 may also receive the contexed event to act upon from event corpus management engine 216.

In addition, the apparatus 200 further comprises an event response generation engine 210 that interfaces with the IESA engine 208 and other components to respond to incoming events and provide and package outputs to a user. The event response generation engine 210 may utilize processor 202, memory 204, or any other hardware component included in the apparatus 200 to perform these operations, as described in connection with FIGS. 3A-5C below. The event response generation engine 210 may further utilize communications hardware 206 to gather data from a variety of sources (e.g., treasury transaction processors 308, described below), and/or exchange data with a user, and in some embodiments may utilize processor 202 and/or memory 204 to manage input and output streams of contexed events and responses. The event response generation engine 210 may comprise a set of knowledgeable APIs that understand the context from the events provided and is configured to formulate calls to FABO engine 212 with the correct set of prompts or data ingestion events.

In addition, the apparatus 200 further comprises a FABO engine 212 that comprises an amalgamation of AI agents that are intelligent in their specific fields of areas in treasury management. The FABO engine 212 may manage models that have knowledge to decipher the context they are operating upon. FABO engine 212 may identify the need of a contexed event and identify the right model and event to get to the model in order to obtain a desired outcome from a respective model knowledge. The FABO engine 212 may utilize processor 202, memory 204, or any other hardware component included in the apparatus 200 to perform these operations, as described in connection with FIGS. 3A-5C below. The FABO engine 212 may utilize processor 202 and/or memory 204 to manage AI agent models, including training and testing of models.

In addition, the apparatus 200 further comprises a treasury optimization engine 214 that may comprise a set of components which are responsible for creating an interface to take actions automatically and call respective banking protocols. For example, in an interest rate change scenario, treasury optimization engine may include components for proprietary API calls and understanding customized rate plans for a specific customer. The treasury optimization engine 214 may standardizing and/or identify liquidity corpus requirements and give suggestions as raw output for processing by other components and subsequent presentation to a user. The treasury optimization engine 214 may utilize processor 202, memory 204, or any other hardware component included in the apparatus 200 to perform these operations, as described in connection with FIGS. 3A-5C below. The treasury optimization engine 214 may further utilize communications hardware 206 to gather data from a variety of sources (e.g., treasury optimization server 108, shown in FIG. 1).

In addition, the apparatus 200 further comprises an event corpus management engine 216 that manages context sets and archived events to provide contexed events for various applications. The event corpus management engine 216 may utilize processor 202, memory 204, or any other hardware component included in the apparatus 200 to perform these operations, as described in connection with FIGS. 3A-5C below. In some embodiments, the event corpus management engine 216 may access or include various ML and/or AI models including language models (LM), or the like, such as those described below stored in memory 204. The LMs may be configured to associate events with various contexts and manipulate or generate contexed events based on text inputs.

In some embodiments, memory 204 may store one or more trained models that may be used by circuitry of apparatus 200 for performing example methods disclosed herein. For example, memory 204 may store parameters for a machine learning (ML) or artificial intelligence (AI) model that, when interpreted and applied with the appropriate circuitry and/or computer program instructions, may perform various ML and AI functions. It will be understood that the apparatus 200 may include specialized circuitry for the use of the stored models and/or model parameters in memory 204, and that applying the stored model parameters with the specialized circuitry of apparatus 200, or loading appropriate instructions for processor 202 in combination with the stored model parameters produces a special-purpose machine comprising the means for performing the example methods involving ML and/or AI models disclosed herein.

Memory 204 may store one or more general models for receiving text-based prompt inputs (and/or multimodal inputs, including audio, images, and/or the like) and providing responses using natural language, such as LMs (sometimes called large language models, LLMs). It will be understood that any components of apparatus 200 described above and/or other components or processes described in connection with FIGS. 3A-3D may make calls to one or more LMs, including specialized algorithms for processing and preparing prompts and interpreting results for certain applications. The general-purpose models stored in memory 204 may be any ML and/or AI model known in the art, including neural networks, decision trees, support vector machines, transformers, various types or variations of neural networks including deep neural networks, autoencoders, convolutional neural networks, recurrent neural networks, and/or the like.

Memory 204 may additionally or alternatively store algorithmic instructions which may be executed by processor 202 or any other attached circuitry of the apparatus 200. The algorithms stored in memory 204 may be compiled code or script language, which may be possible to modify at runtime, for example, by operations of processor 202 or other circuitry of apparatus 200. Algorithms stored in memory 204 may be configurable through the use of various parameters, which may be adjusted before or during run time by processor 202 or other circuitry.

Memory 204 may store a cash awareness model 242 that may provide quantitative predictions of cash flow based on historical input data and model assumptions. For example, the cash awareness model 242 may include predictions of owned non-cash assets and valuation predictions based on market data, and may provide impacts on cash positions based on such computations. Accordingly, the cash awareness model 242 may be a model trained for predicting cash positions based on markets or other financial data. The cash awareness model 242 may be any ML and/or AI model known in the art, including neural networks, decision trees, support vector machines, transformers, various types or variations of neural networks including deep neural networks, autoencoders, convolutional neural networks, recurrent neural networks, and/or the like.

Memory 204 may store a risk control model 244 that may provide a quantitative analysis of risk. In tandem with the cash awareness model 242, risk control model 244 may be configured to suggest certain actions based on risk tolerance parameters and data regarding cash positions and/or market and financial conditions. Accordingly, the risk control model 244 may be an algorithm designed to provide repeatable, explainable recommendations to customers based on financial conditions that are able to be reported for regulatory compliance purposes.

Memory 204 may store agent model 246A through agent model 246N that may perform knowledge-related tasks based on various areas of treasury management. Accordingly, the agent model 246A through agent model 246N may be models trained and/or fine-tuned for a particular knowledge, and/or trained using specially curated training data sets. The agent model 246A through agent model 246N may be any ML and/or AI models known in the art, including neural networks, decision trees, support vector machines, transformers, various types or variations of neural networks including deep neural networks, autoencoders, convolutional neural networks, recurrent neural networks, and/or the like. The agent model 246A through agent model 246N may be general-purpose LMs that are modified with additional training and/or fine-tuning to provide expertise in a particular subject area.

Although components 202-216 and stored data 242-246N are described in part using functional language, it will be understood that the particular implementations necessarily include the use of particular hardware. It should also be understood that certain of these components 202-216 may include similar or common hardware. For example, the IESA engine 208, event response generation engine 210, and FABO engine 212 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” and “engine” with respect to elements of the apparatus therefore shall be interpreted as necessarily including the particular hardware configured to perform the functions associated with the particular element being described. While the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the IESA engine 208, event response generation engine 210, FABO engine 212, treasury optimization engine 214, and event corpus management engine 216 may leverage processor 202, memory 204, or communications hardware 206 as described above, it will be understood that any of IESA engine 208, event response generation engine 210, FABO engine 212, treasury optimization engine 214, or event corpus management engine 216 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that IESA engine 208, event response generation engine 210, FABO engine 212, treasury optimization engine 214, and event corpus management engine 216 comprise particular machinery designed for performing the functions described herein in connection with such elements of apparatus 200.

In some embodiments, various components of the apparatuses 200 may be hosted remotely (e.g., by one or more cloud servers) and thus need not physically reside on the apparatus 200. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatuses 200, example embodiments are described below in connection with a series of graphical user interfaces and flowcharts.

### Example System Design

Turning to FIGS. 3A, 3B, 3C, and 3D, example block diagrams are illustrated that show components and operations implemented by example embodiments described herein, including their relationships and flows of data. The components illustrated in FIGS. 3A-3D (which may include circuitry, engine, or stored data introduced in FIG. 2) may, for example, be implemented by the treasury management system 102 shown in FIG. 1, which may in turn be embodied by an apparatus 200, which is shown and described in connection with FIG. 2. To embody the components described below, the apparatus 200 may utilize one or more of processor 202, memory 204, communications hardware 206, IESA engine 208, event response generation engine 210, FABO engine 212, treasury optimization engine 214, event corpus management engine 216, cash awareness model 242, risk control model 244, agent model 246A-agent model 246N and/or any combination thereof. It will be understood that user interaction with the treasury management system 102 may occur directly via communications hardware 206 or may instead be facilitated by a separate user device 106, as shown in FIG. 1, and which may have similar or equivalent physical componentry facilitating such user interaction.

FIG. 3A shows an overview of the example system design and interactions among components, which are illustrated in further detail in subsequent figures, described below. A user 302 may interact with various components of the treasury management system directly, as illustrated in FIG. 3A, or may interact via a user device 106. In either case, the user 302 may interact with the event response generation engine 210 using a user prompt/response 304. It will be understood that user 302 may represent an individual user, an organization (e.g., a corporation, agency, or the like), a representative thereof, or any other entity that may interact with a treasury, being authorized to access treasury data and funds.

The event response generation engine 210 may respond to events from any number of sources, and in some cases, generate a response to transmit to user 302 via user prompt/response 304. In one example, a user 302 may directly submit a query or request a response vis user prompt/response 304. In another example, an event from a DLT network, such as DLT network 310 or DLT network 312, may be collected and identified by the IESA engine 208, and passed to event response generation engine 210 to prepare a response. In another example, a transaction recognized by treasury transaction processors 308 (including a transaction involving DLT network: digital asset management 306), may trigger generation of a response from event response generation engine. These three examples of events triggering responses are described below in connection with FIG. 5A (DLT-based events), FIG. 5B (customer prompt-based events), and FIG. 5C (treasury transaction events).

The event response generation engine 210, upon receiving and identifying an actionable event, may pass an input stream to FABO engine 212. FABO engine 212 is described in further detail below in connection with FIG. 3B. To formulate a response, the FABO engine 212 may consult historical event data from event corpus 314, which may be curated and provided by the event corpus management engine 216. The event corpus management engine 216 may maintain and curate event corpus 314 in addition to context sets 316, which may be combined with events to prepare contexed events. In some embodiments, over time, the event corpus management engine 216 may record events from IESA engine 208 to develop event corpus 314, and may be trained on information from FABO engine 212 to determine contexts for various events. For example, in the context of cashflow for an outdoor theater, the event corpus management engine 216 may be trained to assign an event comprising a weather forecast to a context involving ticket sales and cashflow.

The FABO engine 212 may, upon determining that a response involves a treasury context, coordinate with treasury optimization engine 214 to perform various actions related to treasury management. As a basic example, a request for a current account balance may trigger a call to treasury optimization engine 214, for example, using retrieval augmented generation (RAG) or other methods, which may access an application programming interface (API) managed by treasury optimization engine 214. The treasury optimization engine 214 may in turn query or forward the query to dedicated servers that may access up-to-date account balances. The treasury optimization engine 214 may then generate an event to transmit to event corpus management engine 216, which may be applied an appropriate context from context sets 316, and may be recorded in event corpus 314. The event corpus management engine 216 may finally pass the contexed event back to FABO engine 212 in response to the original API call or RAG lookup.

Turning to FIG. 3B, FABO engine 212 is shown in additional detail. The FABO engine 212 may comprise an amalgamation of agents, agent model 246A through agent model 246N, which are intelligent in their specific fields or areas in treasury management and have knowledge to decipher the context upon which they may operating. The FABO engine 212 may orchestrate and identify the need of an event and identify the right model, via agent model manager 322, and the right event to get to the model and get the desired outcome from the respective AI models. Accordingly, the agent model manager 322 may orchestrate calls to agent model 246A through 246N. The agent model manager 322 may be configured to map contexed events, prompts, or other requests for response to one or more of the agent model 246A through 246N based on the nature of the question or request, including an associated subject area or domain knowledge. An agent model 246A may make a request to target event agent model call 324 to prepare and format a call to a particular agent model 246A through agent model 246N.

In some embodiments, an agent model call may comprise multimodal inputs (e.g., text and visual data, video, or other input modes), and calls may be routed to multimodal input management 330. Multimodal input management 330 may provide additional API or layers for translating multimodal prompts or other inputs to formats that may be suitable as inputs for one or more of the agent model 246A through agent model 246N.

Additionally, the FABO engine 212 may include various general-purpose pre-trained models, including GAN networks 332 and base LM transformer framework 334. The general-purpose pre-trained models may provide support for one or more of agent model 246A through agent model 246N, or may assist in preparing prompts, interpreting events, or performing other general-purpose tasks, (particularly general language tasks) for agent model manager 322 or other components of FABO engine 212. The base LM transformer framework 334 may include RAG components 336 and/or FNN 338 (feed-forward neural network) as core parts of the LM transformer architecture.

In some examples, inputs received from event response generation engine 210 may be stored as input prompt/document 328, which may be interpreted by agent model manager 322 and prepared by target event agent model call 324 and/or other components for inputs to the agent model 246A through agent model 246N or other AI models. The FABO engine 212 may further store and compile various input embeddings and position encodings 326 that may augment or prepare input prompt/document 328 for use as inputs or prompts for the various FABO engine 212 components.

In some embodiments, the base LM transformer framework 334 and/or other AI models may interact with or utilize reinforcement learning from human feedback, RLHF 340. For example, an evaluation system may be in place, or specialized human feedback agents may provide feedback to fine-tune and provide continuous learning to the base LM transformer framework 334, agent model 246A through agent model 246N, and/or other AI models. In some examples, the RLHF 340 feedback may be received via calls to treasury optimization engine 214, which may be mediated via optimizer call manager 344. In some examples, the RLHF 340 feedback may be provided in the form of contexed events, which may be mediated by the treasury specific context window 342, interfacing with event corpus management engine 216.

The treasury specific context window 342 may mediate calls to and receive data from event corpus management engine 216. The treasury specific context window 342 may facilitate the event corpus 314, via the event corpus management engine 216, being applied within a context window specifically to the event being processed by FABO engine 212. For example, if an interest rate change of 25 basis points would have impact on treasury balances, events from event corpus 314 that provide insight into which areas of the treasury may have impact are included in the context here For example, processing of certain input events may cause one or more models of the FABO engine 212 to request additional information from the event corpus management engine 216, to provide context or to fulfil a data retrieval request.

The optimizer call manager 344 may include an API for interacting with the treasury optimization engine 214, which may enable real-time access to treasure data (e.g., treasury data related to user 302, including accounts and transactions). Optimizer call manager 344 may monitor activities of base LM transformer framework 334 and/or agent model 246A through agent model 246N to interpret requests for real-time treasury data and translate the requests to API calls to the treasury optimization engine 214.

Turning to FIG. 3C, additional detail is shown regarding an example implementation of the treasury optimization engine 214. The treasury optimization engine 214 may include a set of components which are responsible for creating an interface to take actions automatically and call respective banking protocols. For example, in an interest rate change scenario, capabilities may include calling proprietary rate management APIs and understanding the customized rate plans for user 302, including standardizing or identifying the liquidity corpus requirements, and providing suggestions to other components to be prepared as output facing the user 302.

Components of the treasury management system 102 may interact with the treasury optimization engine 214 via a collection of treasury management APIs 354, which may include open-source, internal, and/or proprietary APIs for interacting with various bank or treasury interfaces. Treasury management APIs may also provide interfaces to send and receive data to and from event corpus management engine 216.

Event adapters 360 may be configured to interpret and provide output in the format of events to and from components such as FABO engine 212. Interpreted events may be available for utilization via treasury management APIs 354 and/or passed to various components such as cash awareness model 242. Cash awareness model 242 may include, as discussed previously, various cash forecasting and other related models capable of making quantitative predications from inputs provided by other components of treasury optimization engine 214.

Risk control model 244 may include any risk forecasting models, including quantitative models that forecast risk given data provided by other components of treasury optimization engine 214. The risk control model 244 may act in conjunction with or may, in some embodiments, be identified with the cash awareness model 242.

Liquidity corpus manager 356 may provide an interface to locally stored indications of liquidity for user 302 for all accounts and positions. For example, calls to treasury management APIs 354 may retrieve data that is catalogued using liquidity corpus manager 356 to provide historical data and provide additional support beyond API calls to external systems.

Ledger management 358 may include various software and enterprise applications for managing one or more financial positions of user 302. In some embodiments, ledger management 358 may include features for managing day-to-day financial activities, such as cash flow, assets, and investments, automatically. Ledger management 358 may be configured to receive directives and configuration from other components of the treasury optimization engine 214, for example, changing the way that it manages financial positions on a day-to-day basis.

Turning to FIG. 3D, additional detail is shown regarding an example implementation of the one or more DLT network 110A through DLT network 110N and treasury transaction processors 308, grouped together under the organizational context of DLT networks and treasury 370. In some embodiments, one or more of the DLT network 110A through DLT network 110N may be configured for a specialized purpose. For example, FIG. 3D illustrates DLT network 110A that is specialized for digital asset management, including settlements based on smart contracts. The DLT network 11A configured for digital asset management may comprise a plurality of nodes associated with banks, shown as bank node 372A, bank node 372B, through bank node 372N. The bank nodes may process transactions involving digital assets, and may interface with a collection of treasury transaction processors 308. The treasury transaction processors 308 may include trade finance processors 374, card/payment processors 376, data analytics processors 378, and/or settlement mechanism 380. When interfaced with DLT network 110A, the treasury transaction processors 308 may provide a full view and awareness of financial transactions and cashflow related to trades, customer payments, and other sources that may interface with event response generation engine 210 to trigger various actions.

Additionally, DLT networks 110A through DLT network 110N may be configured to collect data from regulator sources, as shown by DLT network 110B. For example, nodes of the DLT may include a bank node 382A and a federal bank node, FED 382B, Clearing House Interbank Payments System, or CHIPS 382C, and others 382N. The nodes may publish information to DLT network 110B including regulatory polity changes, which may interface with IESA engine 208 to create and provide context for events.

Additionally, DLT networks 110A through DLT network 110N may be configured to collect data from agency sources, as shown by DLT network 110N. For example, nodes of the DLT may include a bank node 384A and other bank nodes represented by others 384N. Bank nodes may publish information to the DLT including macroeconomic events, industry events, and/or pollical events. The DLT network 110N may interface with IESA engine 208 to create and provide context for events collected from various bank nodes.

### Example Operations

Turning to FIGS. 4 and 5A-5C, example flowcharts are illustrated that contain example operations implemented by example embodiments described herein. The operations illustrated in FIGS. 3A-5C may, for example, be performed by the treasury management system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, IESA engine 208, event response generation engine 210, FABO engine 212, and/or any combination thereof. It will be understood that user interaction with the treasury management system 102 may occur directly via communications hardware 206 or may instead be facilitated by a separate user device 106, as shown in FIG. 1, and which may have similar or equivalent physical componentry facilitating such user interaction.

Turning first to FIG. 4, example operations are shown for generating scenarios for treasury management. As shown by operation 410, the apparatus 200 includes means, such as processor 202, memory 204, communications hardware 206, IESA engine 208, event response generation engine 210, or the like, for receiving an event. As discussed previously, the IESA engine 208, as depicted in FIG. 3A, may receive events in one of several modes. For example, modes for receiving events are described below in FIG. 5A, FIG. 5B, and FIG. 5C. In some embodiments, the event response generation engine 210 may directly receive processed events without the involvement of the IESA engine 208, for example, when an external server or service performs event processing (such as one of treasury transaction processors 308).

As shown by operation 415, the apparatus 200 includes means, such as processor 202, memory 204, communications hardware 206, IESA engine 208, or the like, for determining a subject matter context to the event. In some embodiments, the IESA engine 208 may be configured as a DLT plugin for a network such as DLT network 110A through DLT network 110N. The IESA engine 208 may utilize models such as an LM stored in memory 204 to analyze events and determine additional events to provide context to an event received in connection with operation 410.

As shown by operation 420, the apparatus 200 includes means, such as processor 202, memory 204, communications hardware 206, IESA engine 208, or the like, for modifying the event based on the subject matter context to prepare a contexed event. In some embodiments, a contexed event may include a base event data object, which may be, for example, a structured text file with entries corresponding to text descriptions of the event, qualitative data (e.g., the data and time, systems directly related to the event) and/or other metadata. In some examples, the base event data object may be linked to other data, including other event data objects, via metadata of the event. In some embodiments, the event metadata may include descriptions of the nature of the connection to the other events and/or other data, which may form the context of the event. Accordingly, the base event data object together with linked event data and other linked data with descriptions of the nature of the linkages may be considered the contexed event. In some embodiments, the IESA engine 208 (which may be a DLT plugin that attaches to a node of heterogenous DLT network such as DLT network 110A through DLT network 110N) may receive actionable events from the network. Upon receiving the actionable event, the IESA engine may modify the data structure of the event as described above to produce the contexed event.

As shown by operation 425, the apparatus 200 includes means, such as processor 202, memory 204, event response generation engine 210, or the like, for generating a prompt based on the contexed event. In some embodiments, the event response generation engine 210 may use pre-determined prompts and/or prompt templates in conjunction with a general-purpose LM or LM trained/fine-tuned for the preparation of event-context prompt to generate the prompt to pass to other components such as FABO engine 212. For example, the event response generation engine 210 may receive the contexed event data structure, described above, which may be inserted into a prompt template instructing the event response generation engine 210 to decide on a course of action based on an actionable event. As described previously, the contexed event may be initially triggered from a variety of sources from market or regulatory events to user interaction, so the event response generation engine 210 may use a variety of models based on the provenance of the contexed event.

As shown by operation 430, the apparatus 200 includes means, such as processor 202, memory 204, FABO engine 212, or the like, for selecting an agent model based on the subject matter context. The FABO engine 212 may receive a prompt from the event response generation engine 210 and unpack details such as the subject matter context of the contexed event. In some embodiments, the FABO engine 212 may receive the prompt from event response generation engine 210 together the contexed event and additional metadata that may be used in deciding an agent model (e.g., one of agent model 246A through agent model 246N) to which the prompt is directed. In some embodiments, the FABO engine 212 may include databases and/or mappings of various subject matter contexts to the different agent models, as depicted in and described in connection with FIG. 3B.

As shown by decision block 435, the apparatus 200 includes means, such as processor 202, memory 204, FABO engine 212, or the like, for determining that the subject matter context relates to a treasury, wherein the treasury is managed by a customer. In some examples, the FABO engine 212 may be configured to direct prompts based on contexed events to a variety of subject matter areas. A subset of the subject matter areas may relate to treasury management, based on the configuration of FABO engine 212 and other components of apparatus 200. In the event that an actionable contexed event relates to treasury management, the FABO engine 212 may enable API calls and other options related to treasury management, such as the use of treasury optimization engine 214 and associated models and components.

As shown by operation 440, the apparatus 200 includes means, such as processor 202, memory 204, treasury optimization engine 214, or the like, for identifying a persona associated with the customer. The treasury optimization engine 214 may store information regarding profiles of users, for example, using data from a bank or other organization. The treasury optimization engine 214 may maintain or acquire data on personas, which may be groupings or clusters of users that are identified to have similar traits and/or behaviors regarding treasury management. For example, a first persona may include high net worth individual customers, another persona may include small business owners, and yet another persona may include mid-sized regional corporate accounts, each of which may have distinct identifiable patterns in treasury management activities.

As shown by operation 445, the apparatus 200 includes means, such as processor 202, memory 204, event corpus management engine 216, or the like, for identifying a historical contexed event from an event corpus 314. The event corpus 314, as described in connection with FIG. 3A, may comprise pairs of contexed events and descriptions of impacts to a related subject-matter context. The event corpus management engine 216 may, based on directive from FABO engine 212 and/or treasury optimization engine 214, retrieve additional relevant events based on the prompt and actionable contexed event. The additional events may provide information that may influence the responses of agent model 246A through agent model 246N, causing FABO engine 212 to update recommendations and/or actions taken. In some examples, the contexed event may be modified to include a reference, stored in metadata of the contexed event, pointing to the historical contexed event from the event corpus 314.

In some embodiments, event corpus management engine 216 may be configured to add the contexed event to the event corpus 314. For example, the event corpus management engine 216 may build the event corpus 314 using contexed events accumulated over time, including any events processed by IESA engine 208 and/or event response generation engine 210.

As shown by operation 450, the apparatus 200 includes means, such as processor 202, memory 204, treasury optimization engine 214, or the like, for generating, by a cash awareness model 242 and/or one or more of agent model 246A through agent model 246N, a predictive treasury scenario based on the historical contexed event, the treasury, the persona, and the contexed event. The predictive treasury scenario may describe an effect on the treasury related to the contexed event and a possible response available to the persona. For example, the predictive treasury scenario may use predictive analytics and/or predict future liquidity needs and/or cash flow amounts. The prediction of liquidity needs and/or cash flow amounts may leverage persona-level and/or customer-specific transactional data to identify trends and create predictive forecast of the future. In some embodiments, the predictive treasury scenario may perform dynamic cash forecasting, which may take historical transactional data (e.g., from event corpus management engine 216 and/or treasury optimization engine 214) and combine with broader persona/customer or market data to improve cash forecasts. The predictive treasury scenario may further include market data analysis, drawing additional data from markets (including stock pricing, macro-economic data, regulations, and/or the like drawn from event corpus 314) to influence model outcomes.

In some embodiments, the predictive treasury scenario may include stress testing, treasury action settlement, and/or treasury optimization. Predictive treasury scenarios may also include smart contract liquidity management, including execution of off-balance sheet funding or cash positioning based on cash flow forecasts.

As shown by operation 455, the apparatus 200 includes means, such as processor 202, memory 204, treasury optimization engine 214, or the like, for generating, by a risk control model, a risk assessment of the possible response. For example, a risk assessment may include modifying a scenario described above in connection with operation 450 to determine differences in the scenario based on changes to macro variables. The treasury optimization engine 214 may further use quantitative risk assessment models, described in connection with FIG. 2, to provide grounded and explainable risk assessments.

As shown by operation 460, the apparatus 200 includes means, such as processor 202, memory 204, FABO engine 212, or the like, for generating, using one or more of the agent model 246A through agent model 246N, a response to the contexed event comprising the predictive treasury scenario, the possible response, and the risk assessment. The FABO engine 212 may use various components and models described in connection with FIG. 3B to prepare a response, which may include a multimodal component (for example, charts and graphs to accompany cash flow predictions). The FABO engine 212 may utilize, for example, RAG components 336 of base LM transformer framework 334 to augment and formulate a response to user 302, embedding the predictive treasury scenario, the risk assessment, and the possible response with appropriate context.

Based on the response, the communications hardware 206 may provide the response to a user 302 directly or transmit to user device 106 for display to a user, using any means known in the art.

Turning now to FIG. 5A, example operations are shown for receiving information from distributed ledgers for generating events. As shown by operation 510, the apparatus 200 may include means, such as processor 202, memory 204, communications hardware 206, IESA engine 208, or the like, for receiving, by the IESA engine and from a first DLT node (e.g., bank node 382A) of a first DLT (e.g., DLT network 110B), a first DLT event. Similarly, the IESA engine 208 may receive from a second DLT node (e.g., bank node 384A) of a second DLT (e.g., DLT network 110N), a second DLT event. As described previously, the IESA engine 208 may be configured as a DLT plugin, and may accordingly receive DLT events from one or more DLT networks.

As shown by operation 515, the apparatus 200 may include means, such as processor 202, memory 204, IESA engine 208, and/or the like, for generating the event comprising first data from the first DLT event and second data from the second DLT event. For example, the IESA engine 208 may register related synchronous events on multiple DLT networks and create a composite event reflecting the individual DLT events. For example, the IESA engine 208 may create the composite event in a case in which a single real-life event causes two DLT events to be transmitted to DLT networks, for example, on two different blocks of different blockchains. The IESA engine 208 may algorithmically detect the coincidence in time and use LMs or other methods to form a conclusion as to whether the two DLT events are part of one underlying composite event.

In some embodiments determining the subject matter context is based on the first data and the second data, which may be contextual data related to the first DLT event and the second DLT event. The first data and second data may be used in template prompts provided to LMs or other models to determine the relatedness of the first DLT event and the second DLT event, together with quantitative data such as a time coincidence.

In some embodiments, modifying the event comprises structuring the event so that an event metadata object based on the second data is appended to the event. As discussed previously, a contexed event may include metadata linking a first event to a second event. In some embodiments, in place of or in addition to forming a composite event, the metadata of an event may be modified or appended to and reference to the second event may be added.

Turning to FIG. 5B, example operations are shown for receiving events by a customer prompt. As shown in operation 525 and operation 530, apparatus 200 may include means, such as processor 202, memory 204, communications hardware 206, event response generation engine 210, and/or the like for receiving a customer request prompt and processing the customer request prompt to produce a customer event. In some embodiments, the customer event may be the contexed event described in connection with FIG. 4, or the contexed event may include the customer event or a reference to the customer event. The customer event may be the method by which user 302 may proactively query the treasury management system 102 to receive information on demand, in addition to other event generation methods which may function autonomously or in response to external events. For example, the event response generation engine 210 may process the customer request prompt to add metadata (e.g., time and date, location, and/or the like) and augment the customer prompt with any contextual information such as a longer conversation that may be relevant to the customer request prompt.

Turning to FIG. 5C, example operations are shown for receiving events based on treasury transactions. As shown by operation 535 and operation 540, the apparatus 200 may include means such as processor 202, memory 204, communications hardware 206, event response generation engine 210, and/or the like, for receiving an indication of a treasury transaction and generating, based on the indication of the treasury transaction, a transaction event. In some embodiments, the contexed event may be the transaction event, or may comprise the transaction event or a link to the transaction event. In some embodiments, the indication of the treasury transaction is emitted by a smart contract operating on a digital asset DLT. For example, the IESA engine 208 may be configured to interface with a DLT plugin that may collect data from a DLT network 110A configured to digital asset transactions. In contrast to methods relying on informational events taken from DLT networks, the IESA engine 208 may construct a contexed event around an indication of a transaction, for example, of cryptocurrencies, non-fungible tokens, and/or the like. The DLT transactions may provide data supplemental to traditional financial transactions, which may be recorded by one or more of the treasury transaction processors 308 and/or recorded and archived using ledger management 358.

### Conclusion

As described above, example embodiments provide methods and apparatuses that enable improved treasury management by leveraging generative AI to generate predictive scenarios. By evaluating predictive treasury scenarios, example embodiments improve risk mitigation by allowing users to overcome the problems faced by organizations that must manage reserves of cash. Example embodiments empower treasurers in evaluating scenarios and unlocking valuable insights into their cash positions. Furthermore, example embodiments enable treasurers to proactively identify risks, seize opportunities, and optimize cash management strategies.

For example, embodiments contemplated herein identify and mitigate high risk scenarios to reduce financial losses. Example embodiments also enhance working capital efficiency (e.g., account receivables, account payables, cash deployment) to increase working capital turnover. Finally, example embodiments remove manual data processing and other related expenses to save operation time and cost.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving, by an intelligent event standards accumulator (IESA) engine, an event;
determining, by the IESA engine, a subject matter context to the event;
modifying, by the IESA engine, the event based on the subject matter context to prepare a contexed event;
generating, by an event response generation engine, a prompt based on the contexed event;
selecting, by a financial AI bureau orchestrator (FABO) engine, an agent model based on the subject matter context;
determining, by the FABO engine, that the subject matter context relates to a treasury, wherein the treasury is managed by a customer;
identifying, by a treasury optimization engine, a persona associated with the customer;
identifying, by an event corpus management engine, a historical contexed event from an event corpus, wherein the event corpus comprises pairs of contexed events and descriptions of impacts to a related subject-matter context;
generating, by the agent model, a predictive treasury scenario based on the historical contexed event, the treasury, the persona, and the contexed event, wherein the predictive treasury scenario describes an effect on the treasury related to the contexed event and a possible response available to the persona;
generating, by a risk control model, a risk assessment of the possible response; and
generating, by the FABO engine and using the agent model, a response to the contexed event comprising the predictive treasury scenario, the possible response, and the risk assessment.

2. The method of claim 1, wherein the IESA engine is a component of a distributed ledger (DLT), the method further comprising:
receiving, by the IESA engine and from a first DLT node of a first DLT, a first DLT event;
receiving, by the IESA engine and from a second DLT node of a second DLT, a second DLT event; and
generating, by the IESA engine, the event comprising first data from the first DLT event and second data from the second DLT event.

3. The method of claim 2,
wherein determining the subject matter context is based on the first data and the second data,
wherein modifying the event comprises structuring the event so that an event metadata object based on the second data is appended to the event.

4. The method of claim 1, further comprising:
receiving, by communications hardware, a customer request prompt; and
processing, by the event response generation engine, the customer request prompt to produce a customer event, wherein the contexed event comprises the customer event.

5. The method of claim 1, further comprising:
adding, by the event corpus management engine, the contexed event to the event corpus.

6. The method of claim 1, further comprising:
receiving, by the IESA engine, an indication of a treasury transaction; and
generating, by the IESA engine and based on the indication of the treasury transaction, a transaction event, wherein the contexed event comprises the transaction event.

7. The method of claim 6, wherein the indication of the treasury transaction is emitted by a smart contract operating on a digital asset DLT.

8. An apparatus comprising:
an intelligent event standards accumulator (IESA) engine configured to:
receive an event,
determine a subject matter context to the event, and
modify the event based on the subject matter context to prepare a contexed event;
an event response generation engine configured to:
generate a prompt based on the contexed event;
a financial AI bureau orchestrator (FABO) engine configured to:
select an agent model based on the subject matter context, and
determine that the subject matter context relates to a treasury, wherein the treasury is managed by a customer;
a treasury optimization engine configured to:
identify a persona associated with the customer;
an event corpus management engine configured to:
identify a historical contexed event from an event corpus, wherein the event corpus comprises pairs of contexed events and descriptions of impacts to a related subject-matter context;
the agent model configured to:
generate a predictive treasury scenario based on the historical contexed event, the treasury, the persona, and the contexed event, wherein the predictive treasury scenario describes an effect on the treasury related to the contexed event and a possible response available to the persona; and
a risk control model configured to:
generate a risk assessment of the possible response,
wherein the FABO engine is further configured to generate, using the agent model, a response to the contexed event comprising the predictive treasury scenario, the possible response, and the risk assessment.

9. The apparatus of claim 8, wherein the IESA engine is a component of a distributed ledger (DLT), wherein the IESA engine is further configured to:
receive, from a first DLT node of a first DLT, a first DLT event;
receive, from a second DLT node of a second DLT, a second DLT event; and
generate the event comprising first data from the first DLT event and second data from the second DLT event.

10. The apparatus of claim 9,
wherein determining the subject matter context is based on the first data and the second data,
wherein modifying the event comprises structuring the event so that an event metadata object based on the second data is appended to the event.

11. The apparatus of claim 8, wherein the event response generation engine is further configured to:
receive a customer request prompt; and
process the customer request prompt to produce a customer event, wherein the contexed event comprises the customer event.

12. The apparatus of claim 8, wherein the event corpus management engine is further configured to:
add the contexed event to the event corpus.

13. The apparatus of claim 8, wherein the IESA engine is further configured to:
receive an indication of a treasury transaction; and
generate, based on the indication of the treasury transaction, a transaction event, wherein the contexed event comprises the transaction event.

14. The apparatus of claim 13, wherein the indication of the treasury transaction is emitted by a smart contract operating on a digital asset DLT.

15. A computer program product comprising at least one non-transitory computer-readable storage medium storing program instructions that, when executed, cause a system to:
receive an event;
determine a subject matter context to the event;
modify the event based on the subject matter context to prepare a contexed event;
generate a prompt based on the contexed event;
select an agent model based on the subject matter context;
determine that the subject matter context relates to a treasury, wherein the treasury is managed by a customer;
identify a persona associated with the customer;
identify a historical contexed event from an event corpus, wherein the event corpus comprises pairs of contexed events and descriptions of impacts to a related subject-matter context;
generate, by the agent model, a predictive treasury scenario based on the historical contexed event, the treasury, the persona, and the contexed event, wherein the predictive treasury scenario describes an effect on the treasury related to the contexed event and a possible response available to the persona;
generate a risk assessment of the possible response; and
generate, by the agent model, a response to the contexed event comprising the predictive treasury scenario, the possible response, and the risk assessment.

16. The computer program product of claim 15, further comprising additional program instructions that, when executed, cause the system to:
receive, from a first DLT node of a first DLT, a first DLT event;
receive, from a second DLT node of a second DLT, a second DLT event; and
generate the event comprising first data from the first DLT event and second data from the second DLT event.

17. The computer program product of claim 16,
wherein determining the subject matter context is based on the first data and the second data,
wherein modifying the event comprises structuring the event so that an event metadata object based on the second data is appended to the event.

18. The computer program product of claim 15, further comprising additional program instructions that, when executed, cause the system to:
receive a customer request prompt; and
process the customer request prompt to produce a customer event, wherein the contexed event comprises the customer event.

19. The computer program product of claim 15, further comprising additional program instructions that, when executed, cause the system to:
add the contexed event to the event corpus.

20. The computer program product of claim 15, further comprising additional program instructions that, when executed, cause the system to:
receive an indication of a treasury transaction; and
generate, based on the indication of the treasury transaction, a transaction event, wherein the contexed event comprises the transaction event.
